(19) United States
(12) Patent Application Publication
(10) Pub. No.: US 2021/0277656 A1
(43) Pub. Date: Sep. 9, 2021

(54) HOLLOW ELONGATE BUILDING ELEMENT

(71) Applicant: Patrick MOUTSCHEN, Louveigne (BE)

(72) Inventor: Patrick MOUTSCHEN, Louveigne (BE)

(21) Appl. No.: 16/336,754

(22) PCT Filed: Sep. 21, 2017
(86) PCT No.: PCT/EP2017/073924

§ 371 Date: Mar. 26, 2019

(30) Foreign Application Priority Data
Sep. 26, 2016 (BE) BE2016/0151

(51) Int. Cl. E04C 3/12

(52) U.S. Cl. CPC E04C 3/127; B27B 1/005

(57) ABSTRACT

A hollow elongate building element (1) made of composite wood is described. It has a polygonal peripheral structure (3) around the void. Each side of the polygonal peripheral structure (3) is formed of at least a pair of elongate strips (5) of triangular or trapezoidal cross section, which are juxtaposed and reversed relative to one another. The polygonal peripheral structure (3) also exhibits strip-form butting-together means (7, 9) in its corner regions. The various strips (5, 7, 9), which are obtained by radial cuts into logs, are bonded together.

### TECHNICAL FIELD OF THE INVENTION

The present invention relates to a hollow elongate construction element made from composite wood optimised with regard to the mechanical strength thereof.

### INTRODUCTION

Modern man is caring more and more for ecology, which leads him to favour sustainable development in many fields, including that of construction.

Construction companies and architects are responding to this demand by using, for construction elements, renewable insulating materials such as wood, which they tend to use in addition as economically as possible.

Those in the building trade are at the same time seeking to optimise construction elements from the point of view of the strength thereof in order to minimise the size thereof and therefore to maximise the useful space in their buildings. For example, stronger beams may, for equal size, provide longer spans, which may give rise to functional and/or aesthetic effects.

Construction elements must also be as light as possible in order to reduce the energy and therefore the costs related to transport and use thereof.

Finally, in order to promote ecological construction, simple and therefore economical manufacturing methods are sought.

### BACKGROUND TO THE INVENTION

Construction elements made from solid composite wood have already been the subject of improvements with regard to the mechanical strength thereof.

Thus the patent GB 781627 discloses a composite wooden beam composed of pairs of longitudinal strips with a triangular or trapezoidal cross-section juxtaposed and inverted, the strips having been obtained by radial cutting from trunks. The strength of the beam is improved by arranging, in its areas most subject to bending stress, that is to say the top and bottom areas, wood obtained at the periphery of the log. This wood, which is younger and has greater density of annular rings, is stronger.

The following three documents are more recent and relate to similar considerations.

The patent EP 1277552 B1 relates to a method for manufacturing composite beams composed of pairs of longitudinal strips with a solely trapezoidal cross-section juxtaposed and inverted.

The U.S. Pat. No. 5,816,015 also relates to a method for manufacturing composite beams that is limited to strips with a triangular cross-section.

The international application WO2016020848 relates to construction elements more generally such as beams, posts, columns or boards.

The solid-wood construction elements of the aforementioned documents have the drawback that they are relatively heavy.

In order to obtain a greater lightness and to consume less wood, hollow construction elements made from composite wood have been developed.

Thus the documents EP0069121, WO8002709, WO9517565 and NL1017360 refer to hollow elongate construction elements, such as masts, piles or cross-members, that have a polygonal or circular cross-section. As for the application NL8004909, this relates to a construction element with a comparable appearance which, in particular, is able to keep its rectilinear shape and can therefore find an application in the construction sector. Though these elements as depicted appear to have acceptable rigidity, the mechanical strength thereof can be improved.

A need remains for construction elements made from composite wood having excellent mechanical properties combining both rigidity of the element and mechanical strength of the composite wood, while being relatively lightweight and saving on raw materials.

### SUMMARY OF THE INVENTION

One aim of the invention is to procure an elongate construction element made from composite wood that is optimised with regard to the mechanical characteristics thereof in order to produce efficient and functional buildings.

Another aim of the invention is to provide an economical construction element in the context of sustainable development.

To these ends, the construction element of the invention is made from composite wood and is hollow. It has a polygonal peripheral structure around the hollow. Each side of this polygonal peripheral structure is formed by at least one pair of elongate strips with a triangular or trapezoidal cross-section juxtaposed and inverted one with respect to the other. The polygonal peripheral structure furthermore has abutment means in the form of strips in its corner zones. The various strips, which have been obtained by radial cutting from log, are adhesively bonded to each other.

Compared with a solid construction element, in particular a solid beam, a hollow element saves on material in its central zone (close to the neutral axis), where said central zone does not contribute, or only slightly contributes, to rigidity, which is determined by the quadratic moment of inertia influenced by the geometry of the cross-section, and therefore to the strength of the beam. A hollow element is obviously lighter, which saves on transport and handling costs. It therefore has a smaller ecological footprint. Furthermore, a hollow construction element makes it possible to pass utility conduits such as cables and electric wires or pipes inside the element, which reduces the space requirement of these utility conduits and furthermore makes it possible to conceal them.

Having regard to the above, the material is transferred to the periphery of the beam, where it is more effective on a mechanical level, since the beam is the most subjected there to bending stress. This material is furthermore particularly strong because of its particular structure comprising elongate strips with a triangular or trapezoidal cross-section juxtaposed and inverted one with respect to the other. These strips, resulting from radial cuts in trunks, are very strong on a mechanical level because of their high proportion of young wood that is denser and therefore stronger situated at the base (in the case of a triangular cross-section) or at the large base (in the case of a trapezoidal cross-section.

Furthermore, in radial cuts, the annual rings are oriented uniformly with respect to the cutting planes, which means that the wood thus obtained has a smaller variability or standard deviation with regard to its mechanical characteristics (under certain imposed conditions of classification/purging) than that obtained by conventional rectangular cuts. Consequently lower safety can be adopted in defining the strength values to be used for sizing the corresponding construction elements. Higher strengths will result from this, which will have the effect of saving on the raw material. In this regard, the strength values of the European Standard EN 338, which gives the characteristic values of the wood according to the species, can be increased by around 15% to 20%.

Furthermore, the strips obtained by radial cuts are less subject to warping due to the shrinkage of the wood during drying, which reduces any subsequent planing of the wood. In addition, radial cutting of trunks gives rise to less waste and is therefore more economical.

The construction element of the invention is therefore optimised with regard to both the geometry of the cross- section (hollow) and the strength of the composite wood with a view to making it both stronger and lighter. Preferably, the construction element according to the invention is configured as a beam or column.

In a preferred embodiment, the construction element according to the invention has a cross-section that is constant over the entire length thereof. In another embodiment, the polygonal peripheral structure of the construction element according to the invention is quadrilateral. Advantageously, it is rectangular. A rectangular geometry allows easier use.

In an advantageous embodiment, the abutment means of the construction element according to the invention are strips with a triangular or trapezoidal cross-section and comprise, in each corner zone, a central elongate strip and at least one elongate strip forming an abutment disposed on either side of the central strip. The cross-sections of the central strip and those of the strips forming an abutment are oriented so as to produce a cone effect. This arrangement causes, by the cone effect in the corner zones, strong clamping of the various strips when they are bonded and consequently increases the mechanical strength of the construction element. Preferably, the central strip and the strips forming an abutment have a trapezoidal cross-section. In order to achieve the cone effect, the large base of the central strip and the small base of the strips forming an abutment are turned towards the hollow of the construction element.

### BRIEF DESCRIPTION OF THE FIGURES

These aspects as well as other aspects of the invention will be clarified in the detailed description of a particular embodiment of the invention, reference being made to the drawings of the figures, in which:

FIG. 1 is a perspective view of a construction element of the invention in the form of a beam with a rectangular cross-section;

FIG. 2 illustrates the strength of the wood in shrinkage during drying according to the way in which it is taken from a log.

### DETAILED DESCRIPTION OF A PARTICULAR EMBODIMENT OF THE INVENTION

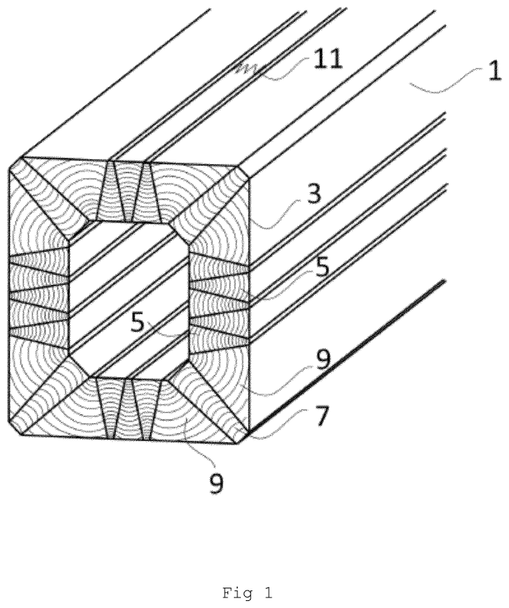

FIG. 1 shows a hollow construction element 1 made from composite wood configured as a beam with a rectangular cross-section that is constant over its length. The beam 1 also has a rectangular peripheral structure 3 around the hollow. The structure 3 as illustrated is formed by five elongate strips 5 (i.e. 2.5 pairs) with a trapezoidal cross-section, juxtaposed, inverted and adhesively bonded for the length of the peripheral structure, and three strips 5 (i.e. 1.5 pairs) for its width. A contiguous means 11 connects the strips 5 longitudinally.

Furthermore, the rectangular peripheral structure 3 has abutment means in each of its corner zones. These comprise, in each of these zones, a central elongate strip 7 with a trapezoidal cross-section and, on either side thereof, an elongate strip forming an abutment 9 also with a trapezoidal cross-section. It should be noted that the trapezia of the strips 9 are inverted with respect to that of the strip 7 and are oriented so as to produce a cone effect in each corner zone: the small bases of the strips 9 and the large base of the strip 7 are turned towards the hollow of the beam 1.

The function of the strips 7, 9 configured in the corner zones is to assist the bonding of the strips 5, 7, 9 constituting the beam 1. This is because, during bonding, a pressure is generated by pressure chambers (not shown) in the hollow of the beam 1 to be assembled and acts on the whole of its strips 5, 7, 9 held for example by hoops (not shown). This pressure then causes, by the cone effect in the corner zones, high reaction forces and consequently strong clamping on the faces of all the strips 5, 7 and 9. This clamping provides a particularly effective bonding of the assembly, which increases the mechanical strength of the beam 1.

The various strips 5, 7, 9 are obtained by radial cutting from logs. Other abutment means could of course be imagined, without departing from the scope of the present invention. The strips 9 may for example be divided into 2 strips with a smaller size.

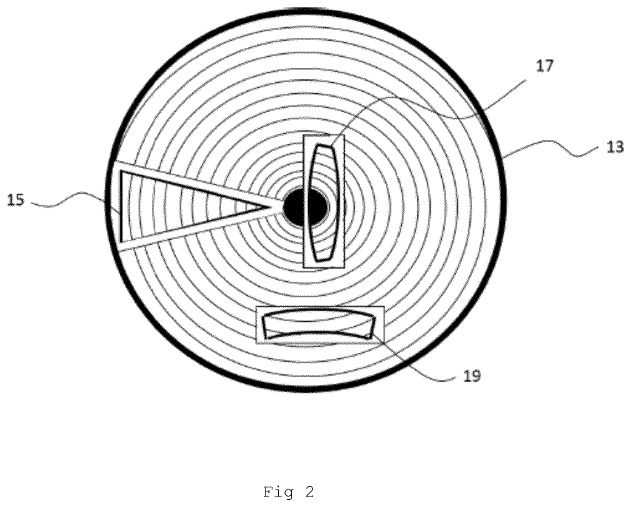

FIG. 2 illustrates the advantages relating to this cutting. A log 13 is subjected to three different cuts. In addition to a radial cut 15, conventional non-radial cuts 17 and 19 are carried out respectively close to the pith and halfway between the pith and the bark.

The cut 17, unlike the radial cut 15, has the double drawback on a mechanical level of containing a relatively large amount of old wood, since it is close to the pith, and therefore much less strong, and having annular rings with opposite orientations.

As shown in FIG. 2, the non-radial cuts 17 and 19 warp on shrinkage during drying, which is not the case with the radial cut 15. This warping is disadvantageous since it involves subsequent machining and therefore loss of material.

It will be obvious to a person skilled in the art that the present invention is not limited to the examples illustrated and described above. The invention comprises each of the novel features as well as a combination thereof. The presence of reference numbers cannot be considered to be limitative. Use of the term “comprises” can in no way exclude the presence of elements other than those mentioned. Use of the definite article “a” for introducing an element does not exclude the presence of a plurality of such elements. The present invention has been described in relation to a specific embodiment, which has a purely illustrative value and must not be considered to be limitative.

1. A hollow elongate construction element (1), comprising composite wood having a polygonal peripheral structure (3) around a hollow, wherein each side of the polygonal peripheral structure (3) is formed by at least one pair of elongate strips (5) with a triangular or trapezoidal cross-section juxtaposed and inverted one with respect to the other, and in that the polygonal peripheral structure (3) further has abutment means in the form of strips (7, 9) in its corner zones, the various strips (5, 7, 9), which were obtained by radial cutting from log (13), being bonded to each other.

2. The construction element according to claim 1, wherein the element is configured as a beam or column.

3. The construction element according to claim 1, wherein the element has a constant cross-section over its entire length.

4. The construction element according to claim 1, wherein the polygonal peripheral structure is quadrilateral.

5. The construction element according to claim 4, wherein the polygonal peripheral structure is rectangular.

6. The construction element according to claim 1, wherein the abutment means in the form of strips (7, 9) have a triangular or trapezoidal cross-section and comprise, in each corner zone, a central elongate strip (7) and at least one elongate strip forming an abutment (9) disposed on either side of the central strip (7), the cross-sections of the central strip (7) and of the strips forming abutments (9) being oriented so as to produce a cone effect.

7. The construction element according to claim 6, wherein the central strip (7) and the strips forming abutments (9) have a trapezoidal cross-section, and in that the large base of the central strip (7) and the small base of the strips forming an abutment (9) are turned towards the hollow of the construction element (1).

8. A building with maximized useful space, the building comprising a structure comprised of a plurality of hollow elongate building elements (1), comprising composite wood having a polygonal peripheral structure (3) around a hollow, wherein each side of the polygonal peripheral structure (3) is formed by at least one pair of elongate strips (5) with a triangular or trapezoidal cross-section juxtaposed and inverted one with respect to the other, and in that the polygonal peripheral structure (3) further has abutment means in the form of strips (7, 9) in its corner zones, the various strips (5, 7, 9), which were obtained by radial cutting from log (13), being bonded to each other.

9. The building of claim 8, wherein the element is configured as a beam or column.

10. The building of claim 8, wherein the element has a constant cross-section over its entire length.

11. The building of claim 8, wherein the construction element according to claim 1, wherein the polygonal peripheral structure is quadrilateral optionally rectangular.

12. The building of claim 8, wherein the abutment means in the form of strips (7, 9) have a triangular or trapezoidal cross-section and comprise, in each corner zone, a central elongate strip (7) and at least one elongate strip forming an abutment (9) disposed on either side of the central strip (7), the cross-sections of the central strip (7) and of the strips forming abutments (9) being oriented so as to produce a cone effect.

13. The building of claim 12, wherein the central strip (7) and the strips forming abutments (9) have a trapezoidal cross-section, and in that the large base of the central strip (7) and the small base of the strips forming an abutment (9) are turned towards the hollow of the construction element (1).
